(19) United States
(12) Patent Application Publication
(10) Pub. No.: US 2026/0317613 A1
(43) Pub. Date: Oct. 15, 2026

(54) DISPERSION OF A WAX IN AN ALKYL METHYL SILOXANE FLUID

(71) Applicants: Dow Global Technologies LLC, Midland, MI (US); Dow Silicones Corporation, Midland, MI (US)

(72) Inventors: Peng Wei, Shanghai (CN); Dorab Bhagwagar, Saginaw, MI (US); Zhengming Tang, Shanghai (CN)

(21) Appl. No.: 19/482,262

(22) PCT Filed: Jun. 13, 2023
(86) PCT No.: PCT/CN2023/100044

§ 371 Date: Nov. 7, 2025

(51) Int. Cl. C09K 5/10; C08G 77/04; C08K 5/01

(52) U.S. Cl. CPC C09K 5/10; C08G 77/045; C08K 5/01

(57) ABSTRACT

Disclosed is a composition which comprising a dispersion of a C₁₆-C₂₈ hydrocarbon wax in an alkyl methyl silicone fluid continuous phase of Formula 1: Formula 1 where R, R¹, m, and n are defined herein. The relative amounts of the wax and the alkyl methyl silicone fluid are such that the viscosity of the dispersion is in the range of from 10 cSt to 100 cSt and the phase change energy absorbed of the dispersion is at least 12 J/g. The composition is useful as a 2-phase immersion cooling fluid.

### BACKGROUND OF THE INVENTION

The present invention relates to a composition comprising a dispersion of a wax in an alkyl methyl siloxane fluid continuous phase. The composition is useful as an immersion cooling fluid for data centers.

Data centers consume vast amounts of energy. Currently, most data centers are air cooled, which is highly inefficient. In a typical data center, only 60% of the total energy is consumed for computation/information requests, data storage, and networking, while 40% is used to remove heat generated by electronic components.

Immersion cooling, where all the data center components are immersed in a dielectric (non-electrically conducting) fluid, is expected to replace air-cooling in the next few years. Examples of dielectric fluids suitable as immersion coolants include fluorinated fluids such as hydrofluoroethers and fluoroketones. The dielectric and chemical inertness of fluorinated fluids make them particularly attractive as heat transfer media, along their wide range of boiling points, low viscosities, low pour points, low surface tension, high thermal and chemical stability as well as compatibility with metals, plastics, and elastomers. These fluids are further advantaged by being odorless, non-flammable, non-explosive, and virtually non-toxic. Moreover, as two-phase immersion fluids that transition from a liquid phase to a vapor phase below the operating temperature of the heat generating components in the server (CPUs and GPUs), fluorinated fluids use the latent heat of the phase transition to extract heat from CPUs and GPUs.

Nevertheless, fluorinated fluids are encumbered by their relatively high vapor pressures, long atmospheric lifetimes, and relatively strong absorbance of infra-red radiation, all of which contribute to severe global warming potential of these fluids. Losses due to evaporation or leakage due to the low fluid surface tension also pose environmental hazards.

Silicone fluids are another class dielectric fluids that show promise as immersion cooling fluids. Like fluorinated fluids, they exhibit low viscosity, low dielectric properties, thermal stability, low flammability, chemical inertness, and low toxicity. Silicone fluids have the additional advantage of being environmentally impermanent; however, as single-phase fluids, they extract heat much less efficiently than fluorinated fluids. It would therefore be an advantage in the field of immersion cooling fluids to discover a medium that meets property and environmental demands.

### BACKGROUND OF THE INVENTION

The present invention addresses a need by providing a composition comprising a dispersion of a C₁₆-C₂₈ hydrocarbon wax in an alkyl methyl silicone fluid continuous phase of Formula 1:

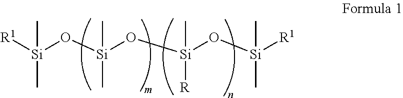

where R and R¹ are each independently methyl or C₆-C₁₈-alkyl, with the proviso that at least one of R and R¹ is C₆-C₁₈-alkyl; where m is from 1 to 20; and n is from 0 to 10; with the further proviso that when n is 0, one or both of the R¹ groups is C₆-C₁₈-alkyl; where the relative amounts of the wax and the alkyl methyl silicone fluid are such that the viscosity of the dispersion is in the range of from 10 cSt to 100 cSt and the phase change energy absorbed of the dispersion is at least 12 J/g. The composition of the present invention is useful as a 2-phase immersion coolant.

### BRIEF DESCRIPTION OF DRAWINGS

FIG. 1 is a dynamic scanning calorimetric thermal analysis of a dispersion of waxes in an alkyl methyl silicone fluid continuous phase.

### DETAILED DESCRIPTION OF THE INVENTION

The present invention is a composition comprising a dispersion of a C₁₆-C₂₈ hydrocarbon wax in an alkyl methyl silicone fluid continuous phase of Formula 1:

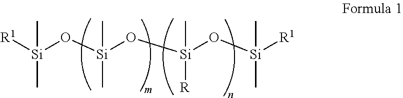

where R and R¹ are each independently methyl or C₆-C₁₈-alkyl, with the proviso that at least one of R and R¹ is C₆-C₁₈-alkyl; where m is from 1 to 20; and n is from 0 to 10; with the further proviso that when n is 0, one or both of the R¹ groups is C₆-C₁₈-alkyl; where the relative amounts of the wax and the alkyl methyl silicone fluid are such that the viscosity of the dispersion is in the range of from 10 cSt to 100 cSt and the phase change energy absorbed of the dispersion is at least 12 J/g. The composition of the present invention is useful as a 2-phase immersion coolant.

The wax may be a single wax or a combination of C₁₆-C₂₈ hydrocarbon waxes having a melting point preferably in the range of from 18° C. to 65° C. In one aspect, each R¹ is methyl, n is from 1 to 10, m is from 1 or from 2, to 10 or to 5; and each R is C₆-C₁₈ alkyl, preferably C₈-C₁₆ alkyl; in a second aspect, n is 0; and at least one of R¹ is C₆-C₁₈ alkyl, preferably each of R¹ is C₈-C₁₆ alkyl; and in a third aspect, n is from 1 to 10; at least one of R¹ is C₆-C₁₈ alkyl, preferably each of R¹ is C₈-C₁₆ alkyl; and each R is C₆-C₁₈ alkyl, preferably C₈-C₁₆ alkyl. Where R and R¹ are C₆-C₁₈ groups, R and R¹ are preferably linear C₆-C₁₈ groups.

Compounds of Formula 1 can be prepared by the catalytic hydrosilylation of a 1-alkene with an organohydrogenpolysiloxane containing internal Si—H groups:

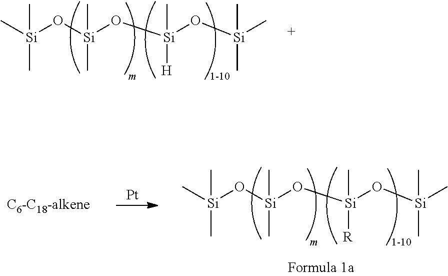

Other compounds of Formula 1 can be prepared from the hydrosilylation of an alkene with an organohydrogenpolysiloxane containing terminal Si—H groups or terminal and internal Si—H groups.

The viscosity and the phase change energy absorbed of the dispersion can be readily tuned to the desired levels by adjusting the proportion of the wax to the alkyl methyl silicone fluid. In general, the weight-to-weight ratio of the wax to the alkyl methyl silicone fluid is in the range of from 3:97 or from 5:95 or from 7:93, to 25:75 or to 20:80 or to 15:85. The wax and the alkyl methyl silicone fluid preferably comprise at least 90 or 95 or 99 or 100 percent of the composition. The composition may optionally further comprise low dielectric and low viscosity fluids such as hydrocarbon and fluorocarbon fluids.

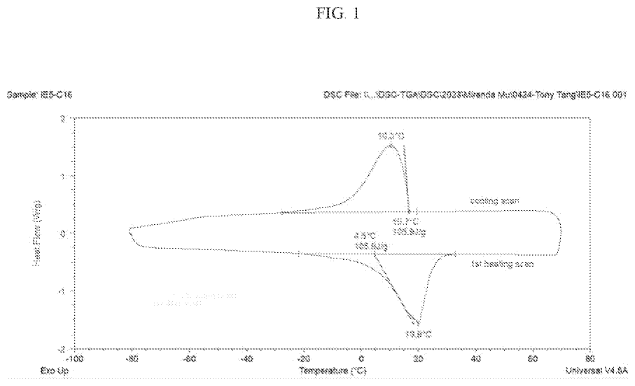

The dispersion exhibits a phase change energy absorbed as determined by dynamic scanning calorimetric thermal analysis (DSC) of greater than 12 J/g, preferably in the range of from 12 J/g to 150 J/g or to 120 J/g or to 110 J/g. The dispersion has a phase change temperature maximum, as determined by DSC preferably in the range of from 5° C. to 60° C. for both heating and cooling cycles. FIG. 1 is a DSC of a dispersion containing 77 parts by weight (pbw) of a compound of Formula 1, where R is n-hexadecyl, m is 3, and n is 6; 18 pbw of a C₁₈ hydrocarbon wax, and 5 pbw of a C₂₂ hydrocarbon wax. The peak temperature of the cooling scan (10.3° C.), the peak temperature of the heating scan (19.9° C.), and the phase change energy absorbed (105.9 J/g) all exceeded the physical property requirements for the composition.

The composition of the present invention addresses a need in the art by providing compositions that have all the property advantages of fluorinated fluids without the environmental drawbacks.

### EXAMPLES

The example and comparative example cooling fluids were prepared by mixing an alkyl methyl silicone fluid with one or more waxes for 30 min using a magnetic stirrer. Sample viscosities at 25° C., phase change temperature maxima for the cool and heating cycles, and phase change energy absorbed were measured by the following methods.

### Viscosity Measurements

Viscosity was measured with a DHR-III viscometer using a 25-mm parallel plate. The flow temperature was ramped from 25° C. to 150° C. at a rate of 3° C./min and a shear rate of 200 s⁻¹.

### Phase Change Measurements

Phase change temperature maxima and phase change energy absorbed were measured using a DSC-Q2000 instrument as follows:

The sample was equilibrated at −80.00° C. Data storage was turned on and the temperature was ramped to 70.00° C. at a rate of 10° C./min to complete the first cycle. The temperature was then decreased to 80.00° C. at the rate of 10° C./min and maintained at this temperature for 3.00 min to complete the second cycle. Finally, the temperature was ramped to 70.00° C. at a rate of C°/min to complete the third cycle.

Heat removal from a device using the two-phase immersion coolant of the present invention is accomplished in two ways. First, the alkyl methyl silicone fluid continuous phase removes heat from the hot device by virtue of having a lower temperature than the device. Second, the phase change energy absorbed by virtue of the melting of the wax disperse phase upon heating provides a second mechanism for heat removal. The higher the phase change energy absorbed, the more efficient the heat removal from the device.

Phase change energy absorbed is calculated by integrating the area under the fusion heat flow endotherm as a function of temperature (enthalpy, See FIG. 1), then dividing the enthalpy by the mass of the test specimen.

Table 1 illustrates the properties of the immersion fluids. Silicone oil (Silicone) is a silicone fluid with a viscosity of 20 cSt. at 25° C. AMS-C₈ refers to an alkyl methyl silicone of Formula 1 where R is n-octyl, each R¹ is methyl, m is 3, and n is 6; and AMS-C₁₆ refers to an alkyl methyl silicone of Formula 1 where R is n-hexadecyl, each R¹ is methyl, m is 3, and n is 6.

The C₁₆ hydrocarbon wax (C₁₆ wax) had a melting point (m.p.) of 18.2° C.; the Cis hydrocarbon wax (C₁₈ wax) had an m.p. of 28.18° C.; the C₂₂ hydrocarbon wax (C₂₂ wax) had an m.p. of 42° C. to 45° C.; and the C₂₄-28 hydrocarbon wax (C₂₄-28 wax) had an m.p. of 49° C. to 64° C. n refers to the viscosity in cSt at 25° C.; T_{c max} refers to the phase change maximum temperature for the cooling cycle; T_{h max} refers to the phase change maximum temperature for the heating cycle; and Eₐ refers to the phase change energy absorbed in J/g. Viscosities in the range of 10 cSt. to 100 cSt., temperatures of phase change maxima in the range of 5° C. to 60° C., and phase change energy absorbed values of >12 J/g were targeted properties of the immersion coolant. All amounts are weight percentages based on the weight of the composition.

TABLE 1
Properties of Immersion Fluids

| | Comp. 1 | Ex. 1 | Ex. 2 | Ex. 3 | Ex. 4 | Ex. 5 | Ex. 6 |
|---|---|---|---|---|---|---|---|
| Silicone | 95 | | | | | | |
| AMS-C8 | | 95 | 95 | 77 | 87 | | |
| AMS-C16 | | | | | | 95 | 77 |
| C₁₆ wax | | | | | 10 | | |
| C₁₈ wax | 5 | | | 18 | | | 18 |
| C₂₂ wax | | 5 | | 5 | | 5 | 5 |
| C₂₄₋₂₈ wax | | | 5 | | 3 | | |
| η (cSt) | 14 | 38.2 | 77.6 | 26 | 32 | 28.6 | 19.3 |
| T_{c max} (° C.) | −4.2 | | 8.7 | 15.8 | 8.2 | 9.4 | 10.3 |
| T_{h max} (° C.) | −8.2 | | 58.1 | 19.0 | 17.7 | 14.2 | 19.9 |
| Eₐ (J/g) | 10.6 | 29.1 | 23.6 | 43.8 | 25.1 | 97.7 | 105.9 |

The data show that the viscosity, the phase change maximum temperatures, and the phase change energy absorbed can be tuned to the desired targets by adjusting the relative amounts and types of waxes and alkyl methyl siloxanes. In contrast, the blend of silicone oil and wax gave unacceptably low phase change maximum cooling and heating temperatures as well as unacceptably low phase change energy absorbed.

1. A composition comprising a dispersion of a C₁₆-C₂₈ hydrocarbon wax in an alkyl methyl silicone fluid continuous phase of Formula 1: 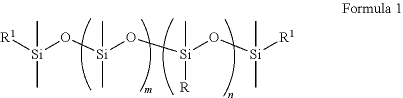
where R and R¹ are each independently methyl or C₆-C₁₈-alkyl, with the proviso that at least one of R and R¹ is C₆-C₁₈-alkyl; where m is from 1 to 20; and n is from 0 to 10; with the further proviso that when n is 0, one or both of the R¹ groups is C₆-C₁₈-alkyl; where the relative amounts of the wax and the alkyl methyl silicone fluid are such that the viscosity of the dispersion is in the range of from 10 cSt to 100 cSt and the phase change energy absorbed of the dispersion is at least 12 J/g.

2. The composition of claim 1 wherein the phase change energy absorbed of the dispersion is in the range of from 12 J/g to 150 J/g; the weight-to-weight ratio of the wax to the alkyl methyl silicone fluid is in the range of from 3:97 to 25:75.

3. The composition of claim 2 wherein n is from 1 to 10; m is from 2 to 10; and each R¹ is a methyl group, wherein the weight-to-weight ratio of the wax to the alkyl methyl silicone fluid is in the range of from 5:95 to 25:75; wherein the phase change energy absorbed of the dispersion is in the range of from 12 J/g to 120 J/g; and wherein at least 90 weight percent of the composition comprises the wax and the alkyl methyl silicone fluid.

4. The composition of claim 2 where n is 0; m is from 2 to 10; and each R¹ is a C₈-C₁₆-alkyl group; wherein at least 95 weight percent of the composition comprises the wax and the alkyl methyl silicone fluid.

5. The composition of claim 2 where n is from 1 to 10; m is from 2 to 10; and each R¹ is a C₈-C₁₆-alkyl group; and wherein the phase change energy absorbed of the dispersion is in the range of from 12 J/g to 110 J/g.

6. The composition of claim 1 wherein the dispersion has a phase change temperature maximum for both heating and cooling cycles in a dynamic scanning calorimetry thermal analysis in the range of from 5° C. to 60° C.

7. A composition that consists of a dispersion of a C₁₆-C₂₈ hydrocarbon wax in an alkyl methyl silicone fluid continuous phase of Formula 1: 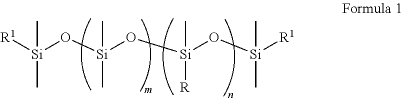
where R and R¹ are each independently methyl or C₆-C₁₈-alkyl, with the proviso that at least one of R and R¹ is C₆-C₁₈-alkyl; where m is from 1 to 20; and n is from 0 to 10; with the further proviso that when n is 0, one or both of the R′ groups is C₆-C₁₈-alkyl; where the relative amounts of the wax and the alkyl methyl silicone fluid are such that the viscosity of the dispersion is in the range of from 10 cSt to 100 cSt and the phase change energy absorbed of the dispersion is at least 12 J/g.
